(19) United States
(12) Patent Application Publication
(10) Pub. No.: US 2022/0187780 A1
(43) Pub. Date: Jun. 16, 2022

(54) SYSTEMS AND METHODS FOR CONTROLLING AND MONITORING FARMS

(71) Applicant: Freight Farms, Inc., Boston, MA (US)

(72) Inventors: Jacob FELSER, Somerville, MA (US); Jonathan FRIEDMAN, Winthrop, MA (US)

(21) Appl. No.: 17/546,333

(22) Filed: Dec. 9, 2021

Related U.S. Application Data
(60) Provisional application No. 63/125,523, filed on Dec. 15, 2020.

(51) Int. Cl. G05B 19/05; G06V 20/10; G06V 10/70; H04L 67/12

(52) U.S. Cl. CPC G05B 19/054; G06V 20/188; G05B 2219/1105; H04L 67/12; G06V 10/70

(57) ABSTRACT

A farming control system for monitoring and controlling one or more contained farms is described herein. The farming control system includes a local system having a plurality of modules to obtain crop data and perform farming operations on crops. The modules transmit the crop data to and receive the farming operations from a local controller, or a cloud controller when the local controller fails. The local system and the cloud system may use machine learning based on the crop data to determine the farming operations to be performed.

### CROSS-REFERENCE TO RELATED APPLICATIONS

The current application claim priority to, and the benefit of, U.S. Provisional Application No. 63/125,523 filed on Dec. 15, 2020, entitled “SYSTEMS AND METHODS FOR CONTROLLING AND MONITORING FARMS,” the entire contents of which are hereby incorporated by reference herein.

### FIELD

Aspects of the present disclosure relate to a system and methods for controlling and monitoring farms.

### BACKGROUND

The need for fresh food is growing as populations increase and changes in climate impact growing seasons. The current food supply model, based on traditional farming methods, may be economically and environmentally unsustainable.

There are many farm control systems on the market. Conventionally, these control systems include programmable logic controllers (PLCs) which have a finite or limited number of actuators and sensors that connect to the PLC. Therefore, the scalability of these control systems may be difficult and expensive to work with. Further, the PLCs are limited in processing capabilities and may create bottlenecks in processing of input and in outputting commands, and may result in a single-point of failure for the control systems.

Therefore, an unmet need remains in the related art for a farm control system, among other needs.

### SUMMARY

The following presents a simplified summary of one or more aspects of the present disclosure in order to provide a basic understanding of such aspects. This summary is not an extensive overview of all contemplated aspects, and is intended to neither identify key or critical elements of all aspects, nor delineate the scope of any or all aspects. Its purpose is to present some concepts of one or more aspects in a simplified form as a prelude to the more detailed description that is presented later.

A farming system configured to monitor various parameters (e.g., water, light, nutrients, growth, disease) of one or more crops of a farm and, based on obtained data, provide automatic or semiautomatic control of farm operations on the farm and/or provide notifications to one or more users associated with the farm, is provided. User control of farm operations may be enabled locally via aspects of a local system and/or remotely via a client system. The farming system may allow scalable solutions over conventional farm controllers due, for example, to the ability to couple virtually unlimited numbers of modules and components for monitoring the farm. Further, aspects of the farming system may provide native support for machine learning, thereby providing autonomous controls and solutions for the farm. Moreover, aspects of the farming system may provide simple solutions for module or component replacements, control redundancy, and rule flexibility due to capabilities of the cloud system.

These and other aspects of the present disclosure will become more fully understood upon a review of the detailed description, which follows.

### BRIEF DESCRIPTION OF THE DRAWINGS

The features believed to be characteristic of aspects of the disclosure are set forth in the appended claims. In the description that follows, like parts are marked throughout the specification and drawings with the same numerals. The drawing figures are not necessarily drawn to scale and certain figures may be shown in exaggerated or generalized form in the interest of clarity and conciseness. The disclosure itself, however, as well as a preferred mode of use and further advantages thereof, will be best understood by reference to the following detailed description of illustrative aspects of the disclosure when read in conjunction with the accompanying drawings, wherein:

FIG. 1 shows a representative block diagram of various features of an example farming system, according to aspects of the present disclosure;

FIG. 2 shows a representative block diagram of various features of an example local control system of the farming system of FIG. 1, according to aspects of the present disclosure;

FIG. 3 shows a representative block diagram of various features of an example farm of the farming system of FIG. 1, according to aspects of the present disclosure;

FIG. 4 shows a representative block diagram of various features of an example cloud control system of the farming system of FIG. 1, according to aspects of the present disclosure;

FIG. 5 shows a representative block diagram of various features of an example client system of the farming system of FIG. 1, according to aspects of the present disclosure;

FIG. 6 shows a representative view of various features of an example user interface screen usable by the farming system of FIG. 1, according to aspects of the present disclosure;

FIG. 7 shows a representative view of various features of another example user interface screen usable by the farming system of FIG. 1, according to aspects of the present disclosure;

FIG. 8 shows a representative view of various features of another example user interface screen usable by the farming system of FIG. 1, according to aspects of the present disclosure;

FIG. 9 shows a representative flow diagram of various features of an example method performed by the farming system of FIG. 1, according to aspects of the present disclosure;

FIG. 10 shows a representative flow diagram of various features of an example method performed by the farming system of FIG. 1, according to aspects of the present disclosure;

FIG. 11 shows an example system diagram of various hardware components and other features, according to aspects of the present disclosure; and

FIG. 12 shows a representative block diagram of various exemplary system components, according to aspects of the present disclosure.

FIG. 13 shows an example of an architectural diagram of the farming system of FIG. 1.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Conventional farm control systems may monitor and control some aspects of a farm, which may, for example, may include one or more modular container based units, such as closed containers with various farm features contained therein (see, e.g., applicants' following co-pending patent applications and issued patents, the entire contents of each of which are incorporated herein by reference: U.S. Pat. No. 9,288,948 titled Insulated Shipping Containers Modified for High-Yield Plant Production Capable in any Environment,” issued Mar. 22, 2016, U.S. Pat. No. 10,271,486 titled Insulated Shipping Containers Modified for High-Yield Plant Production Capable in any Environment,” issued Apr. 30, 2019; pending U.S. patent application Ser. No. 16/398,506 titled Insulated Shipping Containers Modified for High-Yield Plant Production Capable in any Environment,” filed Apr. 30, 2019; U.S. Pat. No. 9,883,642 titled “Vertical Assembly for Growing Plants,” issued Feb. 6, 2018; pending U.S. patent application Ser. No. 15/886,934 titled “Vertical Assembly for Growing Plants,” filed Feb. 2, 2018; U.S. Pat. No. 10,172,301 titled “Insulated Shipping Containers Modified for High-Yield Fungi Production Capable in any Environment,” issued Jan. 8, 2019; pending U.S. patent application Ser. No. 16/240,902 “Insulated Shipping Containers Modified for High-Yield Fungi Production Capable in any Environment,” filed Jan. 7, 2019; pending U.S. patent application Ser. No. 16,091,347 titled “Modular Farm Control and Monitoring System,” filed Oct. 4, 2018; pending U.S. patent application Ser. No. 16/325,808 titled “Modular Farm with Carousel System,” filed Feb. 15, 2019; pending U.S. patent application Ser. No. 16/987,150 titled “Hub and Spoke Modular Farm System,” filed Aug. 6, 2020; and pending U.S. patent application Ser. No. 16/801,092 titled “Closed Farm System with Air Flow Control,” filed Feb. 25, 2020).

The conventional farm control systems may include programmable logic controller (PLC)-based farm controllers. These types of controllers create a hardware backbone (rather than a software backbone), which may result in expensive equipment for monitoring and controlling a farm. Further, conventional farm systems have limitations that may be materially impactful to some farm systems. For example, conventional farm systems may have a finite or limited amount of actuators, may have a finite or limited amount of sensors, may not be scalable up without changing underlying hardware and in many cases communications software, may not be scaled down due to cost-efficiencies, may not natively support machine vision/machine learning pipelines, may have a single or few, immutable failure point(s) at a main controller within the farm, may have different interfaces in the farm and outside the farm, may be run with the hardware inside the farm (e.g., local control systems), reducing cost-effectiveness, and/or may have limited types of control rules applied to sensor inputs and actuator outputs (e.g., 1:1 rules).

Aspects of the present application may overcome deficiencies of conventional control systems. Aspects of the present disclosure provide a farming control system for monitoring and controlling one or more farms as described herein. In an example implementation, the system may be decentralized and include one or more modules (e.g., peripherals that sense the environment or act on it), a controller (e.g., an application that makes rule-based decisions about what actions to take), and a smart engine, such as a machine learning pipeline that provides feedback to the user about the state of the crops or system.

In one example implementation, the farming control system described herein may use a software backbone, rather than a hardware backbone, for maintaining connection to some or every module in the system. As a result, hard limitations on the number of modules or nodes in the system may be avoided, thereby allowing redundancy and multiple failure points to prevent catastrophic system failure, among other advantages. For example, the system may accommodate essentially an infinite number of sensors and actuators. The nodes of the system may be controlled via a system of rules that may link any node to any other node (or several nodes to several other nodes) as described herein.

As a farming control system in accordance with aspects of the present disclosure may have no inherent limitation on a number of nodes in the system, scalability of the system may be straightforward, thereby allowing any particular system to be scaled up or down as needed. A single (or minimized number of) control application(s) may control one module or thousands of modules without any additional overhead.

In one example implementation, a farming control system in accordance with aspects of the present disclosure may provide native support for machine vision/machine learning or other similar algorithms. As a farming control system in accordance with aspects of the present disclosure may have no inherent limitation on a number of nodes in the system, nor the amount of information being passed among those nodes, camera nodes, for example, may be used to pipe imagery to a data lake in the cloud. This data lake may then be subjected to a machine learning algorithm for learning, for example, as each image in the data lake may be correlated to the state of the system when that particular image was taken; accordingly, useful conclusions may be drawn. Those conclusions may then be passed back into the controller application to actuate the system as appropriate.

Further, machine learning conclusions may not be limited to system state conclusions, but in addition may be tagged with any other suitable metadata available, such as plant disease state or plant mass.

In an example implementation, aspects of the present farming control system may include modules that may be replaced independently of all other modules in that system and without substantially interfering with the controller. This approach prevents the failure, common in PLC-based controllers, of one module failure taking out the entire system.

In the event that the controller application crashes in an irrecoverable way or the hardware the controller application is running on in the farm is damaged, the example implementation of the farming control system may be able to quickly start up a replacement controller in the cloud, for example, if the farm in question is coupleable thereto via the Internet or another network. This feature may, among other advantages, prevent downtime at the farm due to local controller failure and may prevent crop loss due to controller failure.

If the farm is coupled to the Internet or another suitable network, for example, the modules may be coupleable to a cloud-based controller, which may in some implementations preclude offline mode, but, for example, enable the farming control system to be deployed at much lower cost. Further, offline mode may be fully or partially supported but in the event, for example, that local hardware is provided as needed.

In view of some or all aspects of the controller application being digital in nature, aspects of a farm control system in accordance with aspects of the present disclosure may support any suitable and potentially unlimited combination of inputs and outputs as part of the logical rules for farm operation. While conventional systems may often be limited to simple direct linkages or if-then statements for logic, for examples, aspects of the present farming control system may be capable of complex rule structures with multiple conditions (e.g., sensor state, output state, and timing conditions) and multiple output actions. In addition, in some example implementations, the output actions may be queued into the future, which, among other advantages, may allow the user to efficiently balance dosing routines and/or any other commonly stacked set of actions.

While, in conventional farm systems, local user interfaces are often limited to small screens, the control system in accordance with aspects of the present disclosure may support the same or a similar interface for both a local user interface and an external user interface (e.g., external client). This capability may exist because the interface from the controller application to the user interface may be similar or identical in both cases due to the software deployed in several places at once in different manners.

In an example implementation, the modular nature of the architecture of the present farm control system may allow relatively easy access to add or replace modules in the future. These modules may encompass any new set of actuators or sensors, including but not limited to actuators and sensors involved with automated farm processes, such as robots or robotic features for automating seeding, transplanting, and harvesting.

Turning to the figures, various features in accordance with aspects of the present disclosure will be discussed in more detail below.

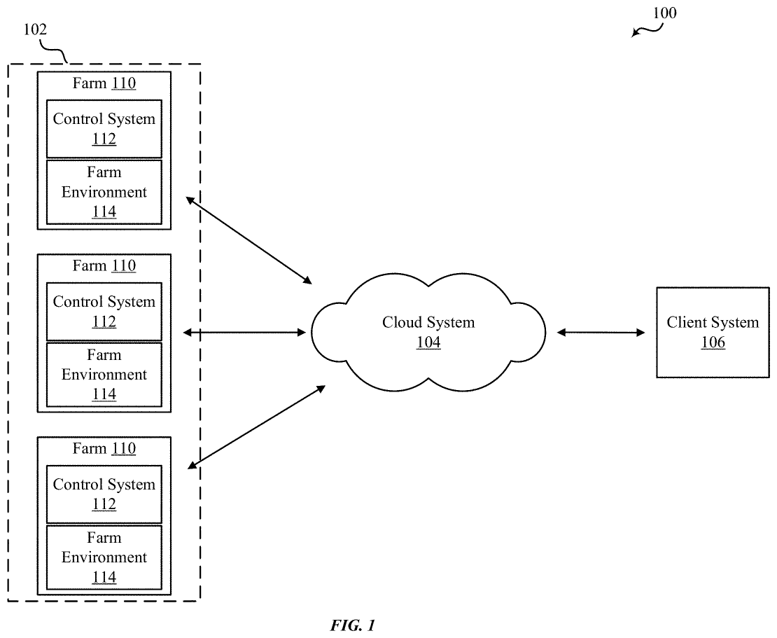

FIG. 1 shows a representative block diagram of a farming system 100 including examples of a local system 102 communicatively coupled with a cloud system 104 and a client system 106. The farming system 100 may provide, for example, monitoring and control of farm operations for the local system 102, which may include one or more farms 110 each having a farm control system 112 for locally controlling and monitoring farming operations at a farm environment 114 for growing one or more crops in a controlled environment.

In an example implementation, the farming system 100 may monitor various parameters (e.g., water, light, nutrients, growth, disease) of one or more crops of the farm environment 114 and, based on obtained data, may provide automatic or semiautomatic control of the farm operations on the farm 110 and/or may provide notifications to one or more users associated with each of the farms 110 via the client system 106. User control of farm operations may be enabled locally via aspects of the local system 102 and/or remotely via the client system 106. As described in further detail herein, aspects of the farming system 100 may allow scalable solutions over conventional farm controllers due, for example, to the ability to couple virtually unlimited numbers of modules and components for monitoring the farms 110. Further, aspects of the farming system 100 may provide native support for machine learning, thereby providing autonomous controls and solutions for the farms 110. Moreover, aspects of the farming system 100 may provide simple solutions for module or component replacements, control redundancy, and rule flexibility due to capabilities of the cloud system 104. Detailed aspects of the local system 102, the cloud system 104, and the client system 106 are provided in more detail herein.

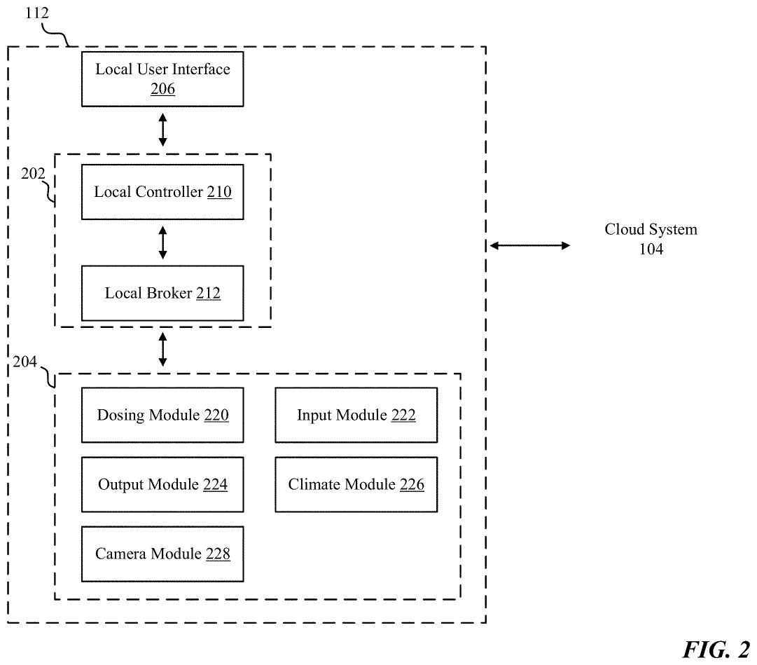

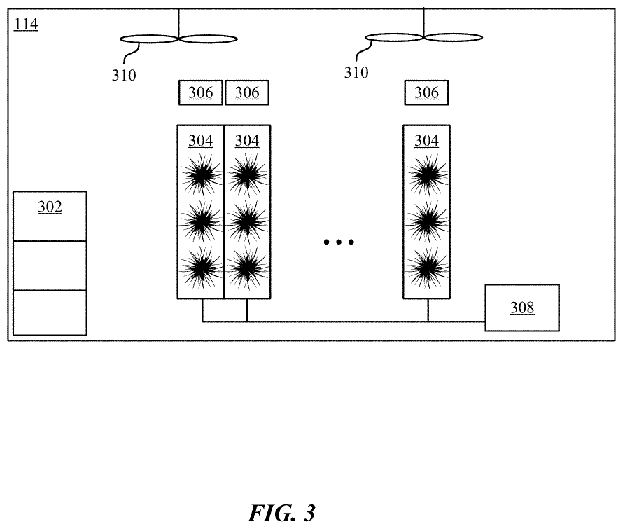

FIGS. 2 and 3 show representative block diagrams of various example features for the local system 102 of FIG. 1. FIG. 2 shows a representative block diagram of various example features of an example farm control system 112 usable in accordance with aspects of the present disclosure. In one example implementation, the farm control system 112 may include a control module 202 communicatively coupled to one or more input/output modules 204 and a local user interface 206. The control module 202 may locally monitor and control crops at the farm environment 114 for example, and communicate with the cloud system 104.

In an aspect, the control module 202 may include a local controller 210 and a local broker 212. In an example of functional operation, the local controller 210 may be configured to locally control operations, as described in more detail herein, of the farm 110. The local controller 210 may include a memory and one or more processors for executing one or more instructions based on input received by the local controller 210 from the local user interface 206, the cloud system 104, and the input/output modules 204, to control aspects of the farm environment 114. For example, the local controller 210 may include a rules engine configured to create rules for controlling outputs of the input/output modules 204 based on one or more inputs received from the input/output modules 204. In an example, the rules engine may include rules for controlling aspects of the farm environment 114 based on any one or more input received by the input/output modules 204.

In an example implementation, the local broker 212 may allow the farm control system 112 to be controlled offline. The local broker 212 may be configured to receive some or all local data (e.g., data from local controller 210 and input/output modules 204) and mediate transfer of the local data to the cloud system 104 and the local system 102. The local broker 212 may allow the local controller 210 to function without the use of the cloud system 104, for example, on a regular basis and/or if communications between the local system 102 and the cloud system 104 are disconnected; thereby, each of the input/output modules 204 may continue to communicate with the local controller 210. Further, because the local broker 212 may provide data to the cloud system 104, for example, the local broker 212 may provide the ability for each of the input/output modules 204 to individually continue to function without the local controller 210, such as by communicating with the cloud system 104, for example, if the local controller 210 or the local broker 212 fails, as described in further details herein.

In an example implementation, the local broker 212 may coordinate instructions for monitoring and controlling of the farm environment 114 by sharing the instructions to both the local controller 210 and the cloud system 104. In an example, the local broker 212 may also direct some instructions or data (e.g., image data) to the local controller 210, as described in more detail herein, for local processing before being sent to the cloud system 104. The local broker 212 may also allow each module 204 to selectively individually couple to the cloud system 104

In an example implementation, the control module 202 and each of the input/output modules 204 may include a wired or wireless network interface for transmitting and receiving data, for example. In an aspect, the network interface, for example, may utilize transmission control protocol/Internet protocol (TCP/IP) packets that may carry commands, parameters, or data. For example, the network interface may receive/transmit message queuing telemetry transport (MQTT) messages. The network interface may forward commands to the corresponding processor of the control module 202 or one of the input/output modules 204 for processing. Conversely, the network interface may receive data generated by a processor of the control module 202 or one of the input/output modules 204 and transmit the data as instructed. In an aspect, the control module 202 and each of the input/output modules 204 may be or include a distributed network or a mesh network allowing one or more of the modules to communicate with a network (e.g., intranet, local area network (LAN), or Internet) through another module.

In an example implementation, the input/output modules 204 may include any suitable number of input devices (e.g., sensors) and output devices (e.g., pumps, motors, lights, temperature control units), or connections to the input devices and output devices, located within the farm environment 114. One or more, or each of the input/output modules 204 may include a memory storing instructions, a processor configured to execute the instructions, and a communication component configured to communicate with the control module 202 and/or the cloud system 104.

An example implementation of the input/output modules 204 may include one or more dosing modules 220 configured to monitor one or more parameter levels (e.g., nutrient levels, electrical conductivity (EC) levels, potential of hydrogen (pH) levels, oxidation reduction potential (ORP), or temperature) of crops in the farm environment 114 and provide one or more doses (e.g., nutrients or other chemicals used to change water parameters) to address the parameter levels of the crops. To monitor and adjust parameter levels, the dosing module 220 may be communicatively coupled to any suitable number of sensors (e.g., EC sensor, pH sensor) for monitoring the crops and any number of pumps (e.g., dosing pump) to provide the doses.

In an example implementation, the input/output modules 204 may also include an input module 222 having one or more generic inputs. For example, the input module 222 may include digital sensors (e.g., 24 volt sensors) and analog sensors (e.g., 4-20 milliamp sensors), and/or connections to digital and analog sensors, for monitoring, for example, water levels, water flow, water depth, or equipment temperatures in the farm environment 114.

The input/output modules 204 may also include an output module 224 having one or more output channels for controlling farm equipment, such as, but not limited to, lighting, pumps, motors for moving lights or other equipment, heating and cooling equipment, airflow, solution reservoirs, or water loops, in the farm environment 114.

In an example, the input/output modules 204 may also include a climate module 226 configured to monitor climate parameters (e.g., humidity, CO₂ levels, air temperature) of the farm environment 114. The climate module 226 may include one or more climate sensors (e.g., humidity sensors, CO₂ meters, temperature sensors) for measuring the climate parameters.

In an example, the input/output modules 204 may also include a camera module 228 configured to capture images of the farm environment 114. For example, the camera module 228 may include one or more cameras that captures images of crops or equipment. The images may be used as input for machine learning and/or automation control of equipment in the farm environment 114. For example, the images may be used for determining or estimating growth or weight of crops. In some examples, the camera module 228 may transfer image data to the local broker 212 in packets, for example, due to limitations on data transmission sizes or other parameters. In such an example implementation, the local broker 212 may identify the packets and allow the local controller 210 to assemble the image.

In an aspect, one or more or each of control module 202 and the input/output modules 204 may include unique identifications used by the control module 202 and/or the cloud system 104 for identifying origination of data transmitted/received and to perform credential verification.

In an example, the local user interface 206 may include one or more input/output devices, such as, but not limited to, a keyboard, a display, a mouse, a touchscreen, a mobile device, a personal computer, and/or a tablet. The local user interface 206 may communicate with the control module 202 through wireless communications (e.g., Bluetooth®, WiFi) or wired communications.

FIG. 3 illustrates a representative conceptual diagram of various features of an example farm environment 114. In an example, the farm environment 114 may be located within a contained area, such as a container or a room of a building. The farm environment 114 may include, for example, a germination station 302 for nurturing crop seeds until they germinate into plants, a plurality of racks 304 configured to hold the growing plants in the farm environment 114, a lighting system 306 to provide appropriate light for the plants, an irrigation system 308 to provide nutrients to the plants, and a climate control system 310 to control the environmental conditions including airflow within the farm environment 114.

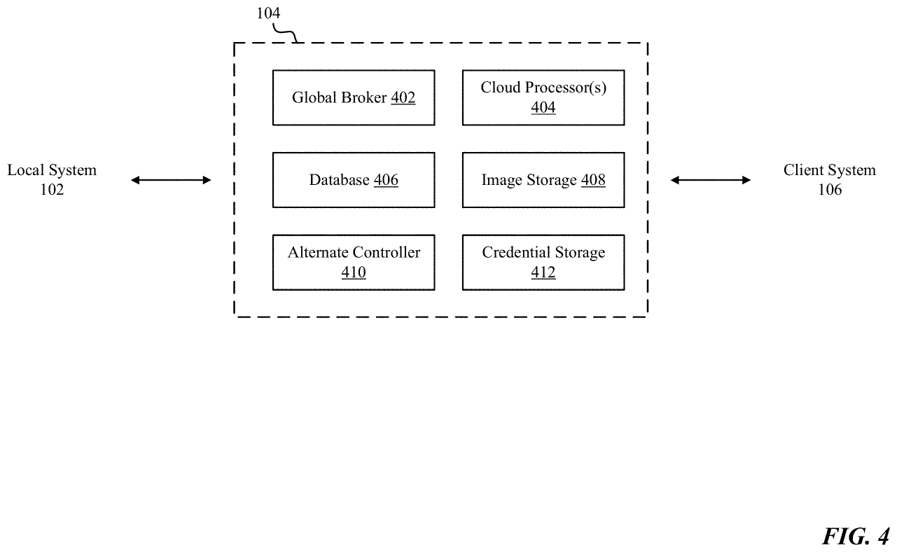

FIG. 4 shows a representative block diagram of various aspects of an example cloud system 104 configured to receive data from the local system 102 for storage or processing and to provide alternate processing application, for example, if the control module 202 or any components (e.g., local controller 210, local broker 212) of the control module 202 fail so as to necessitate such alternate processing. The cloud system 104 may include a global broker 402 configured to manage data received from the local system 102 and manage cloud back-up processing if the control module 202 fails, for example. In an aspect, the global broker 402 may monitor data from the local system 102 and provide data to cloud processors 404 for processing, if not processed by the local system 102, for example. Examples of the cloud processors 404 may include Lambda processing.

The cloud system 104 may also include one or more databases 406 for storing data corresponding to the farms 110. The data may include, but is not limited to, historical state data, current state data, image metadata, application programming interface (API) responses, application data, user credentials, farm data, and/or image data. In an aspect, the cloud system 104 may also include an image storage 408 used to selectively store images received from the local system 102. As described herein, the images may be used for monitoring parameters (e.g., growth, weight, height) of crops, for example.

In another aspect, the global broker 402 may control the local system 102. For example, if the global broker 402 receives an indication that the control module 202 (or a component on the control module 202) has failed, the global broker 402 may activate an alternate controller 410 and/or the cloud processor 404 within the cloud system 104 for processing the data and executing operations for the farm 110, for example. Accordingly, the alternate controller 410 may provide processing for performing some or all operations for the farm 110 until, for example, the control module 202 resumes sufficient operational function. In an example, the global broker 402 may determine the control module 202 (or a component of the control module 202) has failed based on a signal received from any of the input/output modules 204, data from the control module 202 not being received, or data being received directly (e.g., not through the control module 202) from any of the input/output modules 204, for example.

In an aspect, the cloud system 104 may include a credential storage 412 configured to store the unique identifiers of each of the control module 202 and the input/output modules 204. In an example, the farming system 100 may include a security feature requiring a newly to be connected module (e.g., control module 202 or any of the input/output modules 204) to perform credentialing through the cloud system 104 before communicating with the local system 102. For example, when a module 204 is initially installed at the farm environment 114, the module 204 may send a unique identification associated with the module 204 to the cloud system 104 for credentialing. The cloud system 104 may compare the unique identification associated with the module 204 to identifications of all other modules within the farming system 100. If the unique identification does not match another identification (e.g., identification of previously installed module), the cloud system 104 may perform a credentialing process to provide access for the module 204 to the farming system 100. Once the credentialing process is performed, the cloud system 104 may indicate to the local system 102 that the module 204 is valid for new installation. If the unique identification of the module 204 matches another identification, or the credentialing process fails, the cloud system 104 may block the module 204 from joining the farming system 100 and/or provide a notification to a user via, for example, the local user interface 206 or another method.

Further, the farming system 100 may also prevent input/output modules 204 from communicating with the cloud system 104 if the control module 202 is running. Otherwise, the input/output modules 204 may communicate with the cloud system 104.

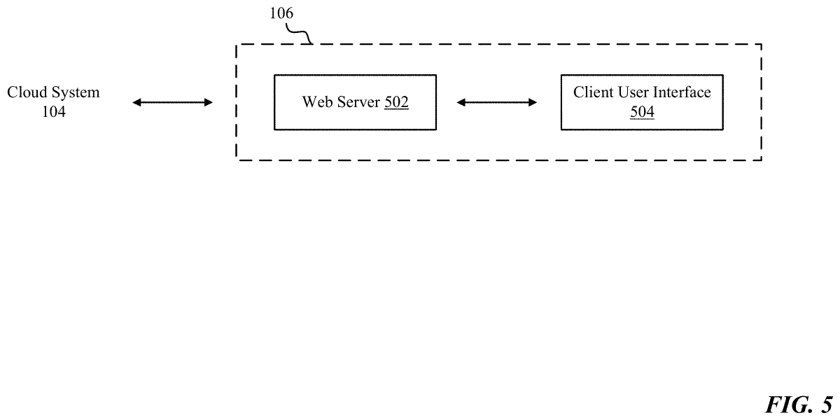

FIG. 5 shows a representative block diagram of an example client system 106 configured to provide remote monitoring and control capabilities for one or more farms 110. The client system 106 may include a web server 502 configured to manage communications between the cloud system 104 and a client user interface 504. In an example, services provided by the web server 502 may include, but are not limited to, login services, mobile services, almanac services, portal services, client services, and/or training services. The web server 502 may communicate with the cloud system 104 and the client user interface 504 by any wireless or wired communications, for example.

In an aspect, the client user interface 504 may be or include one or more input/output devices configured to communicatively couple with the web server 502 and displaying data corresponding to one or more farms 110. Examples of the client user interface 504, may include, but are not limited to, a mobile device, a personal computer, or a tablet.

Example Operations of Farming System 100

In an aspect, each of the input/output modules 204 sends a message to the control module 202 to verify the control module 202 is has not failed. The message may be sent to the control module 202, for example, at a predetermined time (e.g., 5 minutes) since a last communication between the input/output module 204 and the control module 202. In another, example, the message may be sent at a designated time (e.g., every 5 minutes) for the input/output module 204 to message the control module 202.

If the control module 202 (e.g., local controller 210 or local broker 212) is not in a failed state, the local broker 212 may receive the message and send a response to the respective input/output module 204, or the local broker 212 may receive the message and instruct the local controller 210 to send a response to the respective input/output module 204. When a response from the control module 202 is received, the input/output module 204 may continue to communicate with the control module 202 according to instructions from the control module 202.

If the input/output module 204 does not receive a response from the control module 202 (e.g., local controller 210 or local broker 212), the input/output module 204 may indicate to the global broker 402 that the control module 202 is in a failed state. In response, the global broker 402 may have the alternate controller 410 activated to control the input/output module 204. In this example, the alternate controller 410 may gather data for controlling the respective input/output module 204 and/or farm 110 from the database 406 and monitor and control the input/output module 204.

In some examples, if the input/output module 204 does not receive a response from the control module 202, the input/output module 204 may attempt to message the control module 202 an additional number of times (e.g., 1-3) before communicating with the global broker 402. In an example, the input/output module 204 may also reboot before sending a next message to the control module 202.

In an aspect, while the input/output module 204 is being controlled by the alternate controller 410, the input/output module 204 may continue to check whether the control module 202 is not in a failed state by occasionally sending messages to the control module 202. If no response is received from the control module 202, the input/output module 204 remains under the control of the alternate controller 410. Otherwise, the input/output module 204 may switch to being controlled by, and communicating with, the control module 202.

In some examples, if the input/output module 204 is being controlled by the alternate controller 410, the input/output module 204 may reboot at a predetermined time (e.g., every 30 minutes) and attempt to message the control module 202. If no response is received, the input/output module 204 may notify the global broker 402 and remain under the control of the alternate controller 410. Otherwise, the input/output module 204 may switch to being controlled by, and communicating with, the control module 202.

In an aspect, the alternate controller 410 continues to function in the cloud system 104 until none of the input/output modules 204 need to be controlled by the alternate controller 410. For example, if the control module 202 fails, all of the input/output modules 204 will be controlled by the alternate controller 410. However, once the control module 202 communicates with the input/output modules 204 (e.g., control module 202 is fixed and no longer in a failed state), the input/output modules 204 may drop off one at a time, based on a response to messages sent by the input/output modules 204 to the control module 202. The alternate controller 410 may therefore control the input/output modules 204 until the last one stops communicating with the alternate controller 410.

Machine Learning

In an aspect, as shown and described with respect to FIGS. 1-5, the local system 102 and the cloud system 104 may employ pattern processing using the data from the farms 110 and/or additional farms. Pattern processing may include, for example, patterns relevant to crops and operations, such as may relate to crop optimization, equipment optimization, maintenance predictions, workflow optimization, and predicted yields and the like. Pattern processing may also include patterns relevant to local and/or regional market data, such as crop yields, pricing, and demand. In an example, machine learning may be used by the farming system 100 to obtain pattern processing for a particular crop from the farms 110. Key events and outcomes may be added as available, automatically or by user selection, for example, and further explanation or detail may be added, for example, by farmers. Through machine learning, patterns may be discovered and validated across a large set of farm data for the crop and may thereby strengthen and refine the patterns over time. Machine learning techniques may include supervised and unsupervised learning.

More particularly, the local controller 210 of FIG. 2, the cloud processor 404 of FIG. 4, and the alternate controller 410 of FIG. 4 may execute one or more machine learning algorithms based on collected data. In an example implementation, the local controller 210 may have access to the data stored (e.g., in database 406 or image storage 408 of FIG. 4) on the cloud system 104 to perform machine learning or may use local data for the machine learning. For each farm 110, crops may be continually monitored (e.g., periodic schedule), as described herein. Crop parameters may be analyzed and compared based on machine learning and data relevant to, for example, the climate, equipment, and crop yield, which may be collected and analyzed for current best growing parameters and settings.

Examples of crop parameters monitored through machine learning may include, but are not limited to, identification of plant species, assessment of plant weight, assessment of transplant readiness, assessment of harvest readiness, assessment of deficiencies such as nutrient deficiencies (e.g., mobile or immobile nutrient deficiencies), water deficiencies (e.g., pump failure, clogged emitter lines, incorrect watering schedule), light deficiencies (e.g., plant composition/legginess, lack of growth, excessive flowering), airflow deficiencies (e.g., tip burn, cabbaging), pest identification (e.g., mold, bugs), farm equipment failures (e.g., lights not turning on/off properly, pump failures, sensor failures, fan failures), and/or other features, such as incorrect settings or setpoints.

Results of the comparisons and analyses may be stored in the local system 102 (e.g., memory) and/or in the cloud system 104 (e.g., database 406). Updates to existing recipes and rules for a particular crop based on new information from machine learning may be saved, and updates sent to the farms 110. A recipe for a crop may include, for example, optimal climate parameters, nutrient parameters, equipment parameters, and yield parameters throughout a plant's growth lifecycle, as well as optimal transplant and harvest timelines.

In an aspect, the local system 102 and the cloud system 104 of FIG. 1 may be trained to identify the status of crops based on images from the farms 110. For example, the local controller 210 of FIG. 2, the cloud processor 404 of FIG. 4, and the alternate controller 410 of FIG. 4 may be trained to identify growth, weight, height, diseases, infestations, and/or other plant parameters through, for example, comparison and analysis of the images captured by one or more camera modules 228 of FIG. 2 in conjunction with use of image metadata. Based on the identified parameters of the crops, for example, existing recipes and rules may be updated to address various needs of the crops for optimal growth. Image analysis may be performed on all images, some images, or select images captured by one or more camera modules 228 of FIG. 2. For example, image analysis may be randomly performed on some images and/or may be performed on images tagged by a user for analysis to be performed.

Monitoring of various farm operations may be used, for example, to proactively predict and address issues and problems before they arise or before they lead to more serious disruption. The probability and types of issues may be determined as they evolve based on data generated across the farms 110 of FIG. 1, which may, for example, be continuously or intermittently generated. Similarly, maintenance schedules may be set or varied based on machine learning from data generated across the farms 110 of FIG. 1. For example, if data indicates a pattern in the timing of maintenance for a particular piece of equipment, a notification may be sent to users at farms 110 of FIG. 1 with that equipment with a notification of the anticipated maintenance time. As another example based on machine learning, user generated content and market data may provide farmers and farm operators with optimal or otherwise recommended crops to grow based on market demands.

Regional crop supply predictions may be made based on the data gathered from the farms 110 of FIG. 1. For example, using farm climate and equipment data for a particular crop, the final crop yield may be predicted based on a highest possible harvest. For example, data may show that the crop experienced a temperature swing of a certain amount. Based on learning from previous data, for example, the predicted crop yield may be reduced due to this temperature swing. This data may be used to determine an amount of a specific crop that will enter the market in coming weeks, for example. As an output of a farm 110 of FIG. 1 is tracked, a supply calendar may then, for example, be generated to further predict the outcome of planned crops beyond the current harvest.

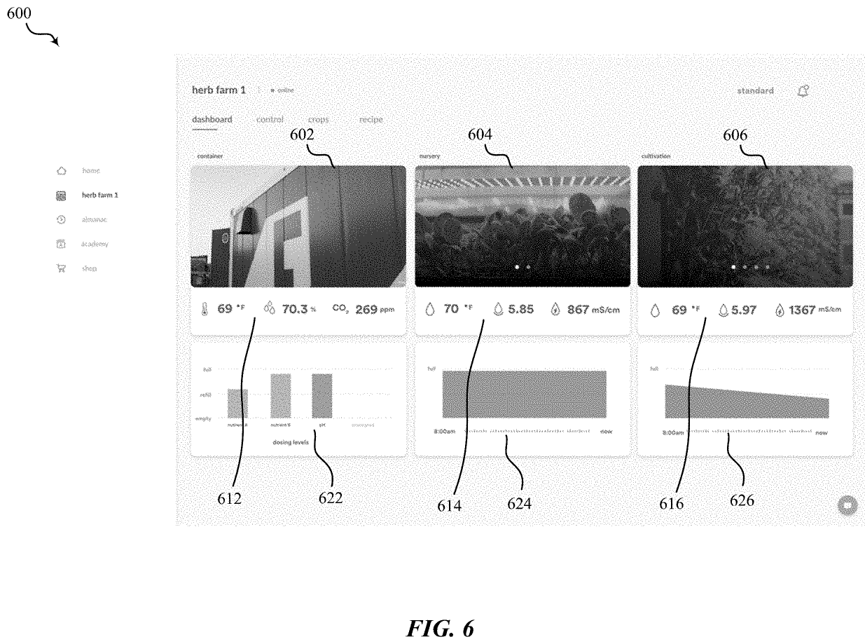

FIGS. 6-8 contain screenshots showing various example aspects of user interfaces for monitoring and controlling the farms 110 of FIG. 1. The user interfaces may be displayed by the local user interface 206 of FIG. 2 and the client user interface 504 of FIG. 5.

FIG. 6 illustrates a screenshot of an example user interface 600 showing a dashboard for viewing aspects of a single farming environment 114 of FIG. 1. In an example, the user interface 600 may display live images of the exterior 602 of the farming environment 114 (e.g., container) of FIG. 1 and different exterior parameters 612 (e.g., air temperature, humidity, CO₂ levels) corresponding the exterior 602 of the farming environment 114 of FIG. 1. In an example, the user interface 600 also displays live images of the crops in the farming environment 114 (e.g., container) of FIG. 1 including crops in a nursery area 604 and the cultivation area 606 of the farming environment 114 of FIG. 1 along with different crop parameters 614 and 616 (e.g., temperature, pH levels, EC levels) corresponding the crops. Additional parameters, such as dosing levels 622, water levels 624 and 626 may also be displayed by the user interface 600.

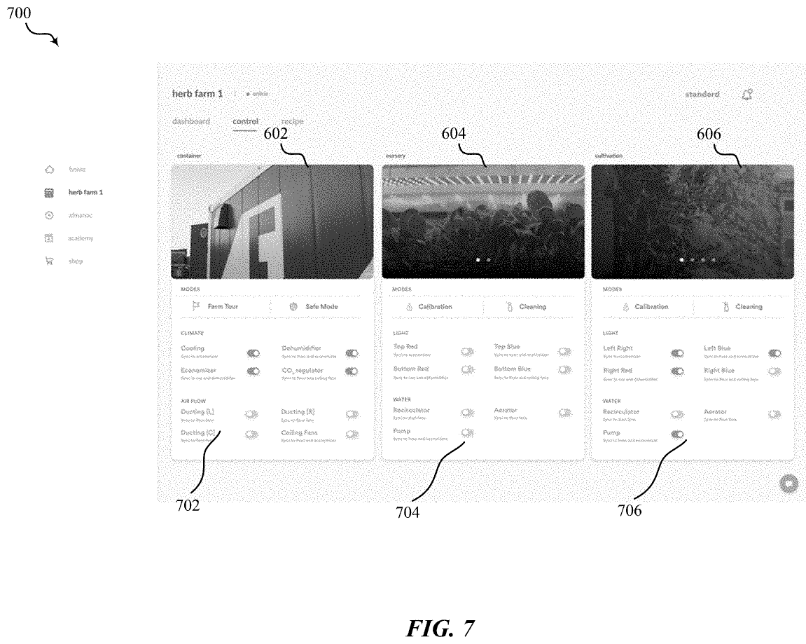

FIG. 7 illustrates a screenshot of an example user interface 700 of a control panel for managing control parameters of the single farming environment 114 of FIG. 1. In an example, the user interface 700 may display control settings corresponding to each of the exterior 602, the nursery area 604, and the cultivation area 606 of the farming environment 114 of FIG. 1. Exterior control parameters 702 may include, but are not limited to, heating and cooling parameters, humidifier/dehumidifier parameters, CO₂ regulation, and air flow for the farming environment 114 of FIG. 1. Nursery control parameters 704 and cultivation control parameters 706 may include, but are not limited to, watering parameters, lighting parameters, nutrient applications (or dosing applications), and localized air flow for the farming environment 114 of FIG. 1.

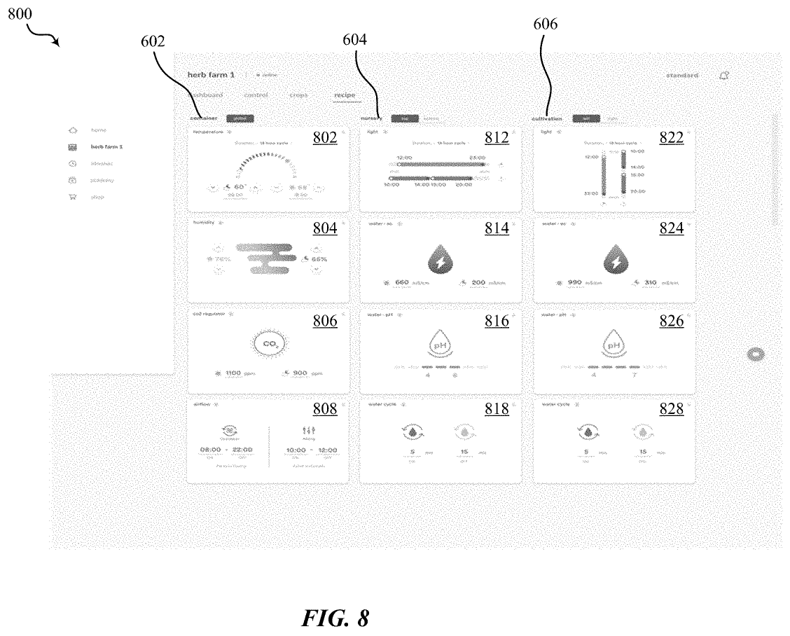

FIG. 8 illustrates a screenshot of an example user interface 800 of a recipe panel for regulation control parameters, such as specific parameters related to specific crops within the single farming environment 114 of FIG. 1. In an example, the user interface 800 may display specific recipe control settings corresponding to each of the exterior 602, the nursery area 604, and the cultivation area 606 of the farming environment 114 of FIG. 1. For example, the regulation control parameters for the exterior 602 may include, but are not limited to, temperature regulation 802, humidity regulation 804, CO₂ regulation 806, and air flow regulation 808. The regulation control parameters for the nursery area 604 and the cultivation area 606 may include, but are not limited to, lighting regulation 812 and 822, EC regulation 814 and 824, pH regulation 816 and 826, and water cycle regulation 818 and 828.

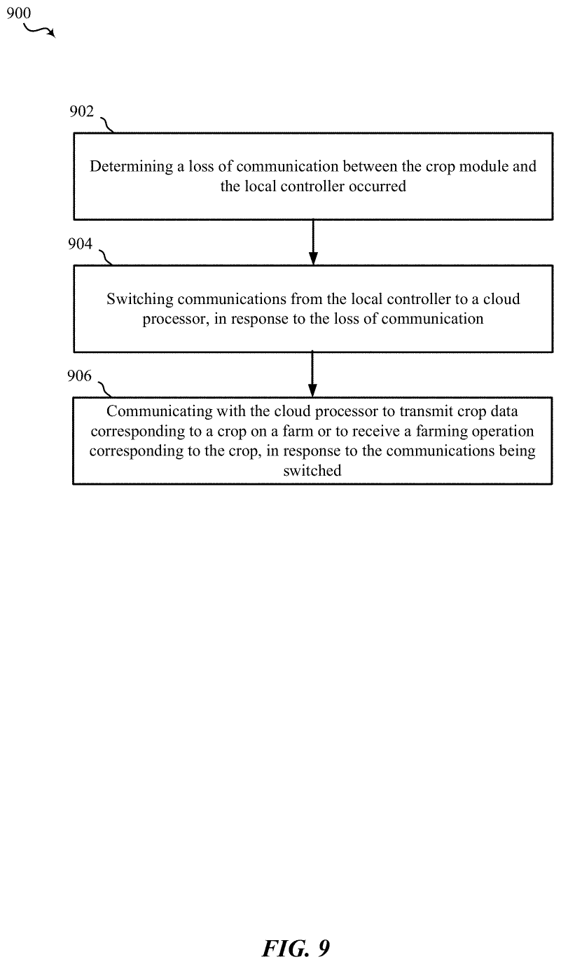

Referring now to FIG. 9, an example method 900 for controlling a farm is illustrated. In an aspect, operations of the method 900 may be performed by one or more components (e.g., input/output module 204 of FIG. 2) of the farming system 100 of FIG. 1.

At 902, the method 900 may include determining a loss of communication between the input/output module 204 and the local controller occurred. In an example, any one of the input/output modules 204 of FIG. 2 may be determined to have a loss of communication with the local controller 210 of FIG. 2. Loss of communication may be due to, for example, the local controller 210 or the local broker 212 of FIG. 2 failing. A input/output module 204 may be determined to have loss of communication based on, for example, the input/output module 204 not receiving a particular response (e.g., acknowledgment/negative acknowledgment) from the local controller 210, or the input/output module 204 receiving an indication from local broker 212 that the local controller 210 has failed.

At 904, the method 900 may include switching communications from the local controller to a cloud processor, in response to the loss of communication. For example, the input/output module 204 of FIG. 2 may configure all transmissions to communicate with the cloud system 104, including one or more components (e.g., global broker 402 or cloud processor 404 of FIG. 2) of the cloud system 104 of FIG. 1, and the input/output module 204 may listen for transmissions from the cloud system 104.

At 906, the method 900 may include communicating with the cloud processor to transmit crop data corresponding to a crop on a farm or to receive a farming operation corresponding to the crop, in response to the communications being switched. For example, the input/output module 204 of FIG. 2 may communicate with the cloud system 104 of FIG. 1.

In an example, the input/output module 204 of FIG. 2 may communicate with the cloud system 104 until the local controller 210 is available for communications.

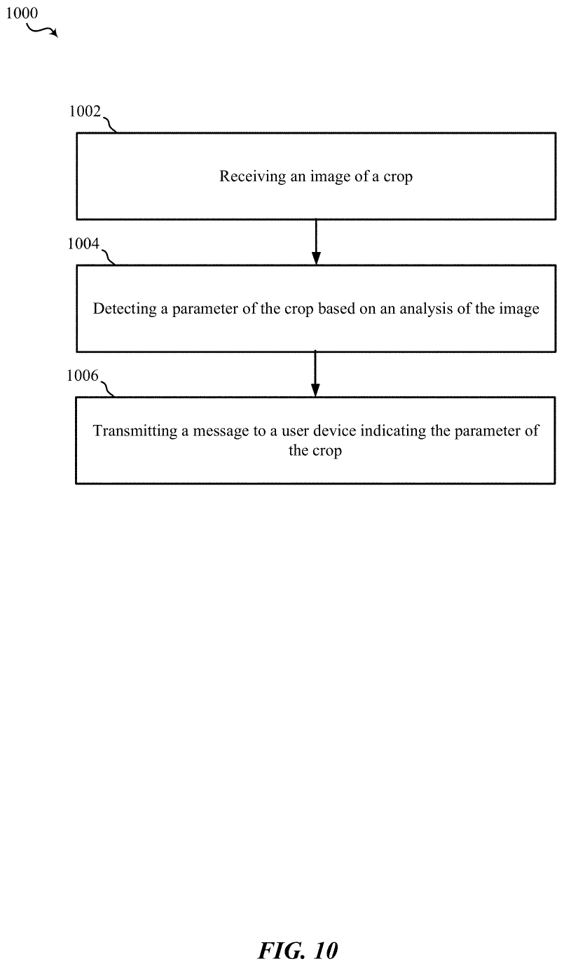

Referring now to FIG. 10, another example of aspects of a method 1000 for controlling a farm is illustrated. In an aspect, operations of the method 1000 may be performed by one or more components (e.g., local system 102 or cloud system 104 of FIG. 1) of the farming system 100.

At 1002, the method 1000 may include receiving an image of a crop. In an example, any one of the local controller 210 of FIG. 2 or the cloud processor 404 of FIG. 4 may receive the image of the crop from the camera module 228 of FIG. 2.

At 1004, the method 1000 may include detecting a parameter of the crop based on an analysis of the image. For example, any one of the local controller 210 of FIG. 2 or the cloud processor 404 of FIG. 4 may detect the parameter of the crop. In an example, the detection of the parameter may be based on machine learning, as described herein. Examples of the parameter may include identification of a plant species or pests, assessment of plant weight, transplant readiness, harvest readiness, deficiencies (e.g., nutrient, water, light, airflow), or identification of farm equipment (e.g., light, pump, sensor, fan, settings) failure.

At 1006, the method 1000 may include transmitting a message to a user device indicating the parameter of the crop. For example, any one of the local controller 210 of FIG. 2 or the cloud processor 404 of FIG. 4 may transmit a message to the local user interface 206 of FIG. 2 or the client user interface 504 of FIG. 5 indicating the parameter of the crop.

In an example, the method 1000 may also include updating a farming operation corresponding to the crop in response to the parameter of the crop. For example, any one of the local controller 210 of FIG. 2 or the cloud processor 404 of FIG. 4 may update a farming operation corresponding to the crop. The update may include updating a crop recipe such as an amount of water, nutrients, light, or airflow for the crop, and/or may include instructions changing a timing of a farm operation (e.g., watering, lighting, airflow) to be performed by farm equipment.

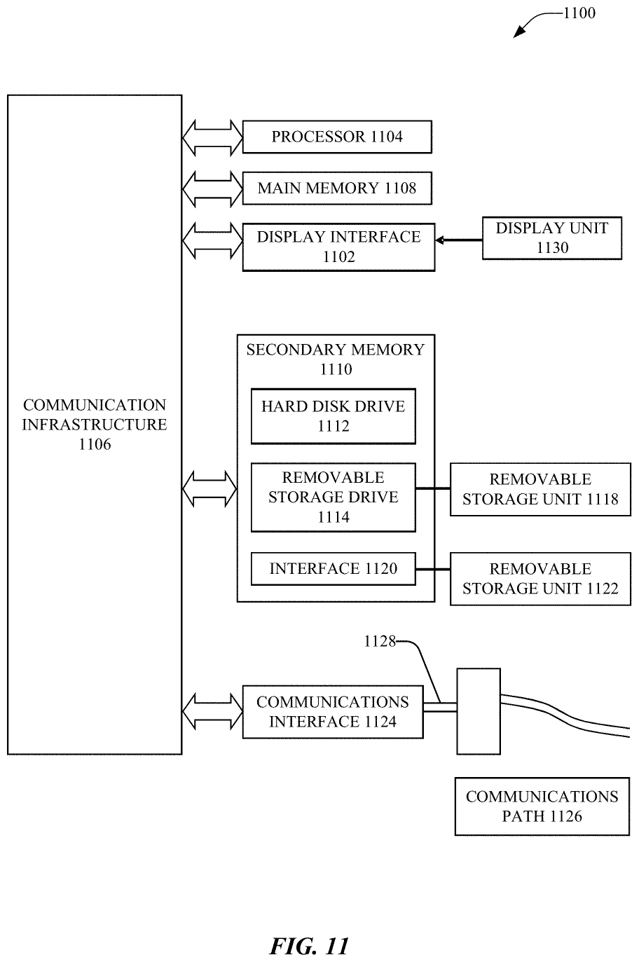

FIG. 11 presents an example system diagram of various hardware components and other features, for use in accordance with an aspect of the present disclosure. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein of the farming system 100. An example of such a computer system 1100 is shown in FIG. 11.

The computer system 1100 includes one or more processors, such as processor 1104. The processor 1104 is connected to a communication infrastructure 1106 (e.g., a communications bus, cross-over bar, or network). The processor 1104 may include a processor for any of the input/output modules 204 of FIG. 2, the local controller 210 of FIG. 2, or the cloud processor 404 of FIG. 4. Various software aspects are described in terms of this example computer system. After reading this description, it will become apparent to a person skilled in the relevant art(s) how to implement aspects described herein using other computer systems and/or architectures.

Computer system 1100 may include a display interface 1102 that forwards graphics, text, and other data from the communication infrastructure 1106 (or from a frame buffer not shown) for display on a display unit 1130. Computer system 1100 also includes a main memory 1108, preferably random access memory (RAM), and may also include a secondary memory 1110. The secondary memory 1110 may include, for example, a hard disk drive 1112 and/or a removable storage drive 1114, representing a floppy disk drive, a magnetic tape drive, an optical disk drive, etc. The removable storage drive 1114 reads from and/or writes to a removable storage unit 1118 in a well-known manner. Removable storage unit 1118, represents a floppy disk, magnetic tape, optical disk, etc., which is read by and written to removable storage drive 1114. As will be appreciated, the removable storage unit 1118 includes a computer usable storage medium having stored therein computer software and/or data.

In alternative aspects, secondary memory 1110 may include other similar devices for allowing computer programs or other instructions to be loaded into computer system 1100. Such devices may include, for example, a removable storage unit 1122 and an interface 1120. Examples of such may include a program cartridge and cartridge interface (such as that found in video game devices), a removable memory chip (such as an erasable programmable read only memory (EPROM), or programmable read only memory (PROM)) and associated socket, and other removable storage units 1122 and interfaces 1120, which allow software and data to be transferred from the removable storage unit 1122 to computer system 1100. In an example, memory for any of the input/output modules 204, the control module 202, or the cloud system 104 may include the module the main memory 1108, the secondary memory 1110, the removable storage drive 1114, the removable storage unit 1118, the removable storage unit 1122, etc.

The computer system 1100 may also include a communications interface 1124. Communications interface 1124 allows software and data to be transferred between computer system 1100 and external devices. Examples of communications interface 1124 may include a modem, a network interface (such as an Ethernet card), a communications port, a Personal Computer Memory Card International Association (PCMCIA) slot and card, etc. Software and data transferred via communications interface 1124 are in the form of signals 1128, which may be electronic, electromagnetic, optical or other signals capable of being received by communications interface 1124. These signals 1128 are provided to communications interface 1124 via a communications path (e.g., channel) 1126. This path 1126 carries signals 1128 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive, a hard disk installed in a hard disk drive, and/or signals 1128. These computer program products provide software to the computer system 1100. Aspects described herein may be directed to such computer program products.

Computer programs (also referred to as computer control logic) are stored in main memory 1108 and/or secondary memory 1110. Computer programs may also be received via communications interface 1124. Such computer programs, when executed, enable the computer system 1100 to perform various features in accordance with aspects described herein. In particular, the computer programs, when executed, enable the processor 1104 to perform such features. Accordingly, such computer programs represent controllers of the computer system 1100.

In variations where aspects described herein are implemented using software, the software may be stored in a computer program product and loaded into computer system 1100 using removable storage drive 1114, hard disk drive 1112, or communications interface 1120. The control logic (software), when executed by the processor 1104, causes the processor 1104 to perform the functions in accordance with aspects described herein as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects described herein are implemented using a combination of both hardware and software.

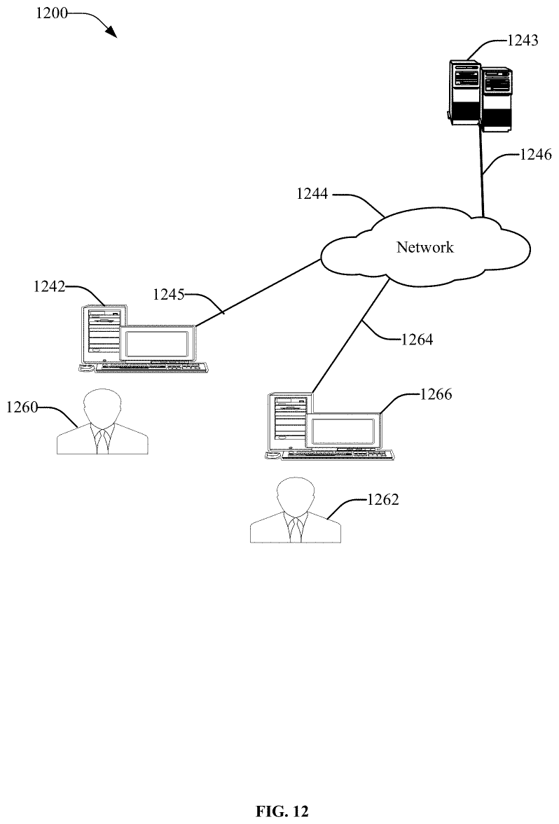

FIG. 12 is a block diagram of various example system components for use in accordance with aspects of the present disclosure. FIG. 12 shows a communication system 1200 usable in accordance with aspects described herein. The communication system 1200 includes one or more users 1260, 1262 and one or more terminals 1242, 1266. For example, terminals 1242, 1266 may include the control module 202 or the client system 106 or a related system, and/or the like. In one aspect, data for use in accordance with aspects described herein is, for example, input and/or accessed by users 1260, 1262 via terminals 1242, 1266, such as personal computers (PCs), minicomputers, mainframe computers, microcomputers, telephonic devices, or wireless devices, such as personal digital assistants (“PDAs”) or a hand-held wireless devices coupled to a server 1243, such as a PC, minicomputer, mainframe computer, microcomputer, or other device having a processor and a repository for data and/or connection to a repository for data, via, for example, a network 1244, such as the Internet or an intranet, and couplings 1245, 1246, 1264. The couplings 1245, 1246, 1264 include, for example, wired, wireless, or fiberoptic links. In another example variation, the method and system in accordance with aspects described herein operate in a stand-alone environment, such as on a single terminal.

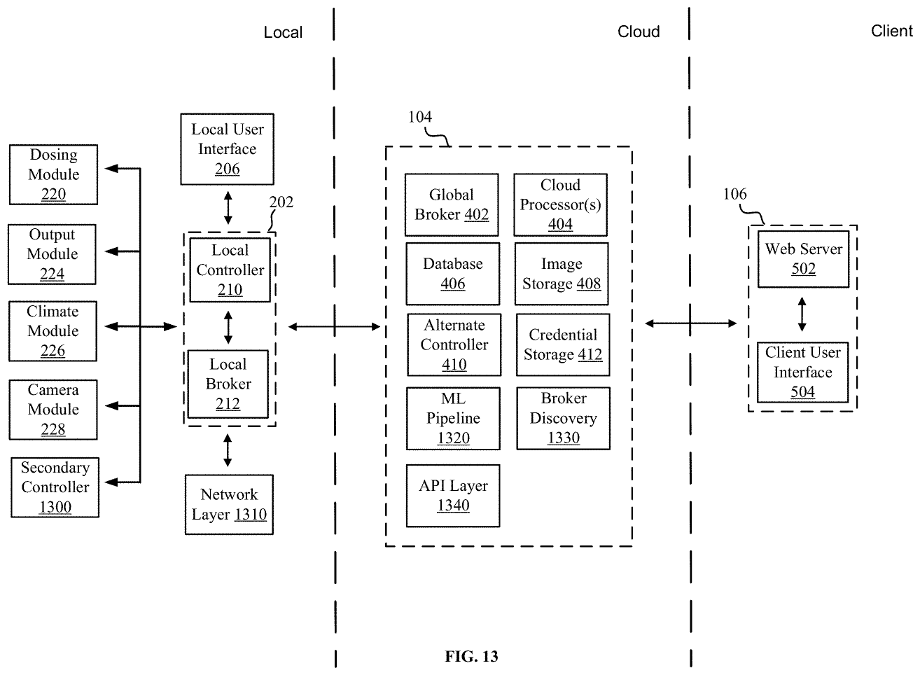

FIG. 13 illustrates an example of an architectural diagram of the farming system 100. In some aspects of the present disclosure, the control module 202 may include the local controller 210 and the local broker 212. The control module 202 may be implemented as software, hardware, or a combination thereof. For example, the control module 202 may be implemented as instructions executable by a computer system, such as the computer system 1100. The control module 202 may include applications executable by one or more processors of a computer system. Examples of the applications may include one or more user interface applications configured to interface with the local user interface 206, the local controller 210, a provisioning script (downloaded and/or executed) for setting network infrastructure (e.g., managing data and/or resources of the control module 202, the local broker 212, and/or other applications. The control module 202 may communicate with a network layer 1310 for exchanging messages with external devices (not shown).

In certain aspects of the present disclosure, the control module 202 may communicate with the one or more dosing modules 220 configured to monitor one or more parameter levels (e.g., nutrient levels, electrical conductivity (EC) levels, potential of hydrogen (pH) levels, oxidation reduction potential (ORP), or temperature) of crops in the farm environment 114 and provide one or more doses (e.g., nutrients or other chemicals used to change water parameters) to address the parameter levels of the crops. To monitor and adjust parameter levels, the dosing module 220 may be communicatively coupled to any suitable number of sensors (e.g., EC sensor, pH sensor, temperature sensor) for monitoring the crops and any number of pumps (e.g., dosing pump) to provide the doses. The dosing module 220 may be implemented as a software, a hardware, or a combination thereof. For example, the dosing module 220 may be implemented as instructions executable by a computer system, such as the computer system 1100. The computer system 1100 may include computer hardware such as processors and/or memory (e.g., random access memory, non-volatile memory, etc.) for storing logical firmware, provisioning script, etc.

In an aspect of the present disclosure, the control module 202 may communicate with the output module 224 having one or more output channels (e.g., 0.1 amp, 24 volt channels) for controlling farm equipment, such as, but not limited to, lighting, pumps, motors for moving lights or other equipment, heating and cooling equipment, airflow, solution reservoirs, or water loops, in the farm environment 114. The output module 224 may be implemented as a software, a hardware, or a combination thereof. For example, the output module 224 may be implemented as instructions executable by a computer system, such as the computer system 1100. The computer system 1100 may include computer hardware such as processors and/or memory (e.g., random access memory, non-volatile memory, etc.) for storing logical firmware, provisioning script, etc.

In one aspect of the present disclosure, the control module 202 may communicate with the climate module 226 configured to monitor climate parameters (e.g., humidity, CO₂ levels, air temperature) of the farm environment 114. The climate module 226 may include one or more climate sensors (e.g., humidity sensors, CO₂ meters, temperature sensors) for measuring the climate parameters. The climate module 226 may be implemented as a software, a hardware, or a combination thereof. For example, the climate module 226 may be implemented as instructions executable by a computer system, such as the computer system 1100. The computer system 1100 may include computer hardware such as processors and/or memory (e.g., random access memory, non-volatile memory, etc.) for storing logical firmware, provisioning script, etc.

In some aspects, the control module 202 may communicate with the camera module 228 configured to capture images of the farm environment 114. For example, the camera module 228 may include one or more cameras, camera sensors, and/or image sensors that captures images of crops or equipment. The images may be used as input for machine learning and/or automation control of equipment in the farm environment 114. For example, the images may be used for determining or estimating growth or weight of crops. The camera module 228 may be implemented as a software, a hardware, or a combination thereof. For example, the camera module 228 may be implemented as instructions executable by a computer system, such as the computer system 1100. The computer system 1100 may include computer hardware such as processors and/or memory (e.g., random access memory, non-volatile memory, etc.) for storing logical firmware, provisioning script, etc.

In one aspect, the farming system 100 may include an auxiliary controller 1300 configured to control one or more of the dosing module 220, the output module 224, the climate module 226, and/or the camera module 228. The auxiliary controller 1300 may be implemented as a software, a hardware, or a combination thereof. For example, the auxiliary controller 1300 may be implemented as a computer system, such as the computer system 1100, one or more PLCs, one or more field-programmable gate arrays, one or more programmable logic devices (PLDs), and/or a combination thereof.

In one implementation, the control module 202 may control the operations of one or more of the dosing module 220, the output module 224, the climate module 226, and/or the camera module 228 via the auxiliary controller 1300. For example, the dosing module 220, the output module 224, the climate module 226, and/or the camera module 228 may transmit data (e.g., ambient/soil temperature, humidity, images, etc.) to the auxiliary controller 1300. The auxiliary controller 1300 may relay the data to the control module 202. Based on the received data, the control module 202 may determine dosing, target temperature, target humidity, and/or other parameters. The control module 202 may transmit commands indicating the dosing, target temperature, target humidity, and/or other parameters to the auxiliary controller 1300. The auxiliary controller 1300 may directly control the operations of one or more of the dosing module 220, the output module 224, the climate module 226, and/or the camera module 228.

In a different implementation, the control module 202 may control the operations of one or more of the dosing module 220, the output module 224, the climate module 226, and/or the camera module 228 directly without going through the auxiliary controller 1300. Alternatively or additionally, the control module 202 may toggle between directly and/indirectly (via the auxiliary controller 1300) controlling the dosing module 220, the output module 224, the climate module 226, and/or the camera module 228.

In an aspect, the cloud system 104 may include the global broker 402 configured to manage data received from the local system 102 and manage cloud back-up processing if the control module 202 fails, for example. In an aspect, the global broker 402 may monitor data from the local system 102 and provide data to cloud processors 404 for processing, if not processed by the local system 102, for example. The cloud system 104 may include the cloud processors 404 to process the data received from the local system 102 during failure.

In some aspects, the cloud system 104 may include one or more databases 406 for storing data corresponding to the farms 110. The data may include, but is not limited to, historical state data, current state data, image metadata, application programming interface (API) responses, application data, user credentials, farm data, and/or image data. In an aspect, the cloud system 104 may also include an image storage 408 used to selectively store images received from the local system 102. As described herein, the images may be used for monitoring parameters (e.g., growth, weight, height) of crops, for example.

In one aspect, the cloud system 104 may include the alternate controller 410 configured to gather data for controlling the output module 224 from the database 406 and monitor and control the output module 224 (for example, during the failure of the local controller 210). In some implementations, the alternate controller 410 may resume at least a portion of the operations of the local controller 210 when the local controller 210 is unavailable (e.g., due to failure, maintenance, upgrade, etc.).

In some aspects of the present disclosure, the cloud system 104 may include the credential storage 412 configured to store the unique identifiers of each of the dosing module 220, the output module 224, the climate module 226, the camera module 228, and/or the auxiliary controller 1300. In an example, the farming system 100 may include a security feature requiring a newly to be connected module to perform credentialing through the cloud system 104 before communicating with the local system 102. For example, when the new module is initially installed, the new module may send a unique identification associated with the new module to the cloud system 104 for credentialing. The cloud system 104 may compare the unique identification associated with the new module to identifications of all other modules within the farming system 100. If the unique identification does not match another identification (e.g., identification of previously installed module), the cloud system 104 may perform a credentialing process to provide access for the new module to the farming system 100. Once the credentialing process is performed, the cloud system 104 may indicate to the local system 102 that the new module is valid for new installation. If the unique identification of the new module matches another identification, or the credentialing process fails, the cloud system 104 may block the new module from joining the farming system 100 and/or provide a notification to a user via, for example, the local user interface 206 or another method.

In some aspects of the present disclosure, the cloud system 104 may include a machine learning pipeline 1320 that provides feedback to the user about the state of the crops or system. The cloud system 104 may employ pattern processing using the data from the farms 110 and/or additional farms, such as crop growth, market supply and/or demand, or other parameters as described above. Based on the pattern processing, the machine learning pipeline 1320 may provide feedback, guidance, suggestions, and/or commands to the modules of the farming system 100.

In certain aspects, the cloud system 104 may include a broker discovery module 1330 configured to detect one or more local or remote brokers within the farming system 100.

In one aspect, the cloud system 104 may include an API layer 1340 that provides an interface between for the client system 106 (or the user of the client system 106) to access features of cloud system 104 and/or the control module 202. The API layer 1340 may include one or more interfaces for exchanging farm data, image data, controller responses, application data, authentication, commands, requests, or other information among the cloud system 104, the control module 202, and/or the client system 106. In one example, the API layer 1340 may include an API gateway as an interface with the client system 106.

In some aspects of the present disclosure, the farming system 100 may include one or more built-in pipelines (e.g., image pipelines, data pipelines, etc.) for enabling machine learning. For example, data and/or images collected by the local controller 210 may be forwarded to the cloud system 104 automatically for refining the machine learning algorithm.

Certain aspects of the present disclosure includes the client system 106 configured to provide remote monitoring and control capabilities for one or more farms 110. The client system 106 may include a web server 502 configured to manage communications between the cloud system 104 and a client user interface 504. In an example, services provided by the web server 502 may include, but are not limited to, login services, mobile services, almanac services, portal services, client services, and/or training services. The web server 502 may communicate with the cloud system 104 and the client user interface 504 by any wireless or wired communications, for example. The client user interface 504 may be or include one or more input/output devices configured to communicatively couple with the web server 502 and displaying data corresponding to one or more farms 110. Examples of the client user interface 504, may include, but are not limited to, a mobile device, a personal computer, or a tablet. In certain implementations, mobile devices may communicate directly with the cloud system 104 via the API layer 1340.

In some aspects, the control module 202 and/or the cloud system 104 may assign a unique identifier (e.g., Universal Unique Identifier) to each of the dosing module 220, the output module 224, the climate module 226, the camera module 228, and/or the auxiliary controller 1300. The control module 202 may communicate with the modules via various communication protocols. In some aspects, control module 202 and/or the cloud system 104 may communicate with the modules without IP and/or Modbus address constraints. A remote controller, such as the alternate controller 410, may remotely control a number of modules even if some of the modules share the same Internet Protocol (IP) addresses. In some instances, the alternate controller 410 may remotely control hundreds or thousands of modules.

In one implementation, the dosing module 220, the output module 224, the climate module 226, the camera module 228, and/or the auxiliary controller 1300 may require software installations (e.g., drivers) to be controllable by the control module 202 and/or the cloud system 104. The modules 220, 224, 226, 228 and/or the auxiliary controller 1300 may be hardware and/or software that utilize different API, programming languages, architectures, etc., as the control module 202 and/or the cloud system 104. After the installation of the software, the modules 220, 224, 226, 228 and/or the auxiliary controller 1300 may be controllable by the control module 202 and/or the cloud system 104. The modules 220, 224, 226, 228 and/or the auxiliary controller 1300 in the current example may be third party hardware and/or software. Alternatively or additionally, software drivers may be installed onto other peripherals (e.g., cameras) to be controlled by the control module 202 and/or the cloud system 104.

One advantage of an aspect of the present disclosure includes providing different drivers for different controllers without changing the underlying logic, data pipelines, backend, etc. of the farming system 100.

Another advantage of an aspect of the present disclosure includes orchestrating across controllers (e.g., synchronizing environmental control in a number of growing space across several controllers in different areas.

One advantage includes augmenting existing controllers with peripherals (e.g., cameras, alarm systems, etc.) to enhance the functionalities of the PLC controllers.

Additional Example Implementations

An example farming control system, comprising: an input/output module configured to obtain data corresponding to a crop on a farm or to perform a farming operation corresponding to the crop; a local controller communicatively coupled with the input/output module and configured to manage a parameter of the crop; and a cloud controller configured to selectively communicate with the input/output module in response to a loss of communication between the input/output module and the local controller, wherein the cloud controller is configured to optionally manage the parameter of the crop until the input/output module is able to communicate with the local controller.

The above example farming control system, further comprising: a global broker configured to manage communications from the input/output module with the cloud controller, wherein the input/output module is further configured to determine the local controller has failed and transmit a message to the global broker indicating the local controller failed.

One or more of the above example farming control systems, wherein both the local controller and the cloud controller are further configured to manage the parameter of the crop based on input from the input/output modules and one or more second input/output modules.

An example input/output module for a farming control system, comprising: a transceiver; a memory storing instructions; one or more processors communicatively coupled with the transceiver and the memory and configured to: determine if a loss of communication between the input/output module and the local controller occurred; switch communications from the local controller to a cloud processor, in response to a determination of the loss of communication; and communicate with the cloud processor to enable transmission of crop data corresponding to a crop on a farm or receiving of a farming operation corresponding to the crop, in response to the communications being switched.

The above example input/output module, wherein the one or more processors are further configured to: transmit a message to the local controller while communicating with the cloud processor; and switch communications from the cloud processor to the local controller, in response to receiving a response to the message from the local controller.

One or more of the above example input/output modules, wherein the one or more processors are further configured to: transmit, to a global broker, a request to communicate with the cloud processor, in response to the determination of the loss of communication.

A second example farming control system, comprising: a memory storing instructions; a processor communicatively coupled with the memory and configured to: receive image data for a crop; detect a parameter of the crop based on an analysis of the image data; and transmit a message to a user device indicating the detected parameter of the crop.

The above second example farming control system, wherein the processor is further configured to: enable update of a farming operation corresponding to the crop in response to the parameter of the crop; and enable transmission of the farming operation to a input/output module to execute the farming operation.

The aspects of the disclosure discussed herein may also be described and implemented in the context of computer-readable storage medium storing computer-executable instructions. Computer-readable storage media includes computer storage media and communication media. For example, flash memory drives, digital versatile discs (DVDs), compact discs (CDs), floppy disks, and tape cassettes. Computer-readable storage media may include volatile and nonvolatile, removable and non-removable media implemented in any method or technology for storage of information such as computer readable instructions, data structures, modules or other data.

This written description uses examples to disclose aspects of the present disclosure, including the preferred embodiments, and also to enable any person skilled in the art to practice the aspects thereof, including making and using any devices or systems and performing any incorporated methods. The patentable scope of these aspects is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, may be mixed and matched by one of ordinary skill in the art to construct additional embodiments and techniques in accordance with principles of this application.

What is claimed is:

1. A farming system, comprising:
an input/output module configured to obtain data corresponding to a crop on a farm or to perform at least one farming operation corresponding to the crop;
an auxiliary controller configured to control the input/output module to perform the at least one farming operation; and
a local controller communicatively coupled with the input/output module and the auxiliary controller and configured to indirectly control the input/output module to perform the at least one farming operation through the auxiliary controller.

2. The farming system of claim 1, wherein the local controller is further configured to directly control the input/output module to perform the at least one farming operation.

3. The farming system of claim 1, wherein the input/output module includes one or more of:
an output module configured to control one or more farming equipment;
a dosing module configured to monitor one or more parameter levels of the crop or provide one or more doses to the crop;
a climate module configured to measure one or more climate parameters in an area associated with the crop; or
a camera module configured to capture an image of the crop and output the image of the crop.

4. The farming system of claim 3, further comprising:
a cloud controller configured to selectively communicate with the input/output module in response to a loss of communication between the input/output module and the local controller, wherein the cloud controller is configured to optionally control the input/output module to perform the at least one farming operation until the input/output module is able to communicate with the local controller.

5. The farming system of claim 4, further comprising:
a global broker configured to manage communications from the input/output module with the cloud controller, wherein the input/output module is further configured to determine the local controller has failed and transmit a message to the global broker indicating the local controller failed.

6. The farming system of claim 4, wherein both the local controller and the cloud controller are further configured to perform the at least one farming operation based on input from the input/output module.

7. The farming system of claim 1, wherein the input/output module is further configured to:
receive image data of a crop; and
transmit the image data to a cloud system.

8. The farming system of claim 7, further comprising the cloud system configured to:
receive the image data;
analyzing the image data;
detect a parameter of the crop based analyzing the image data; and
transmit a message to a user device indicating the detected parameter of the crop.

9. The farming system of claim 8, wherein the cloud system is further configured to transmit an update message to the local controller or the input/output module indicating an update of the at least one farming operation corresponding to the crop in response to the detected parameter of the crop.

10. The farming system of claim 8, wherein analyzing the image data comprises analyzing the image data based on machine learning.

11. The farming system of claim 8, wherein the cloud system is further configured to
receive, from a plurality of farms, crop data, equipment data, workflow data, yield data, and market data associated with the crop;
detect a pattern associated with the crop based on the crop data, the equipment data, the workflow data, the yield data, and the market data using machine learning;
generate a second message associated with performing the at least one farming operation based on the pattern; and
transmit the second message to the local controller.

12. The farming system of claim 1, wherein the local controller is further configured to:
receive an input from the input/output module associated with the crop;
create one or more rules for controlling an output to the input/output module for performing the at least one farming operation; and
generating the output to the input/output module based on the one or more rules and the input.

13. A local controller for performing at least one farming operation, comprising:
a memory storing instructions;
an interface;
a processor communicatively coupled with the memory and the interface, the processor is configured to execute the instructions to:
transmit, via the interface, a control signal to an input/output module to perform the at least one farming operation corresponding to a crop on a farm; or
transmit, via the interface, a control signal to an auxiliary controller to control an input/output module to perform the at least one farming operation corresponding to a crop on a farm.

14. The local controller of claim 13, wherein:
the input/output module is further configured to obtain data corresponding to the crop; and
the auxiliary controller configured to control the input/output module to perform the at least one farming operation without input from the local controller.

15. The local controller of claim 13, wherein the input/output module includes one or more of:
an output module configured to control one or more farming equipment;
a dosing module configured to monitor one or more parameter levels of the crop or provide one or more doses to the crop;
a climate module configured to measure one or more climate parameters in an area associated with the crop; or
a camera module configured to capture an image of the crop and output the image of the crop.

16. The local controller of claim 13, wherein the processor is further configured to execute the instructions to:
receive an input from the input/output module associated with the crop;
create one or more rules for controlling an output to the input/output module; and
generating the output to the input/output module based on the one or more rules and the input.

17. An input/output module for a farming control system, comprising:
a transceiver;
a memory storing instructions;
one or more processors communicatively coupled with the transceiver and the memory and configured to:
determine if a loss of communication between the input/output module and a local controller occurred;
switch communications from the local controller to a cloud processor, in response to a determination of the loss of communication; and
communicate with the cloud processor to enable transmission of crop data corresponding to a crop on a farm or receiving of a farming operation corresponding to the crop, in response to the communications being switched.

18. The input/output module of claim 17, wherein the one or more processors are further configured to:
transmit a message to the local controller while communicating with the cloud processor; and
switch communications from the cloud processor to the local controller, in response to receiving a response to the message from the local controller.

19. The input/output module of claim 17, wherein the one or more processors are further configured to:
transmit, to a global broker, a request to communicate with the cloud processor, in response to the determination of the loss of communication.
